(19) United States
(12) Patent Application Publication
(10) Pub. No.: US 2009/0301350 A1
(43) Pub. Date: Dec. 10, 2009

(54) USE OF PYROGENIC METAL OXIDE FOR THE MANUFACTURE OF A SELFCOMPACTING COMPOSITION COMPRISING HYDRAULIC BINDERS

(75) Inventors: Christoph Tontrup, Alzenau (DE); Reinhard Trettin, Netphen (DE); Michael Geyer, Beckum (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa Gmbh, Essen (DE)

(21) Appl. No.: 12/299,479

(22) PCT Filed: Mar. 12, 2007
(86) PCT No.: PCT/EP2007/052309

§ 371 Date: Feb. 25, 2009

(30) Foreign Application Priority Data
May 5, 2006 (DE) 10 2006 020 877.3

(51) Int. Cl. C04B 14/04; C01B 33/12; C01G 23/047; C01F 7/02; C01G 25/02; C01B 33/26; C01B 33/20; C04B 14/30; C04B 14/36

(52) U.S. Cl. 106/442; 423/335; 423/610; 423/625; 423/608; 423/328.1; 423/326; 106/482; 106/436; 106/401; 106/450; 106/483; 106/446

(57) ABSTRACT

Use of pyrogenic metal oxide for the manufacture of a selfcompacting composition comprising hydraulic binders and having high early strength, the composition comprising at least one hydraulic binder and water as further constituents and the product of the BET surface area, in m²/g, of the pyrogenic metal oxide and the proportion by weight of the pyrogenic metal oxide based on the hydraulic binder being 20 to 200 m²/100 g of hydraulic binder.

The invention relates to the use of pyrogenic metal oxides for the manufacture of selfcompacting compositions which comprise hydraulic binders and have high early strength.

In Japan, the development of flowable selfcompacting concretes and mortars began in the mid 1980s (Deutscher Ausschuss für Stahlbeton: Sachstandsbericht Selbstverdichtender Beton [German Committee for Reinforced Concrete: Progress Report of Selfcompacting Concrete], 1st edition, 2001). Advantages of selfcompacting concrete over conventional concrete are substantially lower installation costs (time-consuming compacting by shaking is dispensed with) and greater work and environmental friendliness (no shaking, less noise). In addition, complicated structural forms and structural forms having a good surface character (for example exposed concrete) can also be produced without aftertreatment.

Selfcompacting concretes and mortars are understood as meaning concretes and mortars which have good flow and compact (deaerate) under their own weight. A criterion for good flow behaviour is the slump (cf. for example DIN 1048-1). In the case of concretes, slumps of >700 mm are characteristic of selfcompacting concrete. Instead of the slump of the concrete, it is also possible to determine that of the corresponding mortar (concrete without coarse fraction >4 mm) according to DIN 18555 Part 2. According to Okamura (Okamura, H.; Ozawa, K., Concrete Library of JSCE 25, pages 107-120, 1995) mortars and the corresponding concretes are selfcompacting if the slump is >24.5 cm. In the present text, selfcompacting compositions comprising hydraulic binders are designated SCC.

In addition to the flow behaviour, the stability to separation is a substantial quality criterion for selfcompacting concretes since the high slumps are achieved as a rule by a high dose of concrete plasticizer. At a high dose of concrete plasticizer, however, the tendency to separate is particularly high. Separation is not desired because this leads to so-called bleeding, which manifests itself in the formation of a more or less thick water layer with added residues on the surface of the concrete after some time. Bleeding occurs because the cement and aggregate particles tend to settle owing to their higher density. They displace the lighter water upwards, said water entraining fine fractions of the cement. Provided it does not evaporate, the water which has emerged during bleeding is completely or partly taken up again later on by the hardened cement paste (Weigler/Karl; “Beton Arten-Herstellung-Eigenschaften [Concrete Types—Manufacture—Properties]”; Ernst&Sohn Verlag). However, an unattractive deposit remains behind on the surface. As a result of the settling of the aggregates, the transport behaviour too is adversely affected. Separation is therefore in any case undesired in the case of selfcompacting concretes and mortars.

In order for the highly plasticized selfcompacting concrete or mortar nevertheless to have stability to separation, it is necessary to increase the powder particle fraction <125 μm substantially (Okamura, H.; Ozawa, K., Concrete Library of JSCE 25, pages 107-120, 1995). Compared with standard concrete, this results in a reduction of 2-16 mm aggregate, an increase of 0-2 mm sand and an increase of the powder particle fraction, defined as particles having a particle diameter of less than 125 μm.

There are in principle two concepts for avoiding separation. Firstly, the powder particle fraction can be increased by adding more cement. However, this leads to unnecessary, high final strengths of the concrete which are even undesired since they give rise to additional costs resulting from designing the construction for a higher strength. Alternatively, so-called stabilizers which increase the viscosity of the fresh concrete and hence avoid separation can be used. Organic additives, such as guar meal, xanthan and cellulose ether, which stabilize the concrete in a gel-like manner, can be used for this purpose. Silica sols, silica fume, limestone powder and fly ash or mixtures of the abovementioned compounds are widely used as stabilizing inorganic fine additives.

Use of silica fume as a stabilizer of the concrete structure is based on the pozzolanic reactivity, the filling effect and the resultant improvement of the contact zone between hardened cement paste and rock particles (Schrimpf, M.; Lietzmann, M.; Orgass, M.; Dehn, F., LACER 7, pages 85-96, 2002).

A disadvantage of the SCC according to the prior art is the often unsatisfactory early strength thereof. It is generally known that the organic and inorganic additives described above and used for stabilization do not have a great effect on the early strength. The technical object of the present invention was therefore to provide selfcompacting mortars and concretes which have improved early strength compared with the prior art without impairing the advantages of the SCC (high slump without separation).

The invention relates to the use of pyrogenic metal oxide for the manufacture of a selfcompacting composition comprising hydraulic binders and having high early strength,
the composition comprising at least one hydraulic binder and water as further constituents and
the product of the BET surface area, in m²/g, of the pyrogenic metal oxide and the proportion by weight of the pyrogenic metal oxide based on the hydraulic binder being 20 to 200 m²/100 g of hydraulic binder.

A composition comprising hydraulic binders and having high early strength is to be understood as meaning a composition which, at any desired time in the first 48 hours of hardening of the SCC, achieves strengths which are at least 30% higher than the reference value of a system without pyrogenic metal oxide.

A composition comprising hydraulic binders means any type of composition in which hydraulic binders are mixed with water and optionally aggregates of different size. Accordingly, the composition comprising hydraulic binders comprises both the hydraulic binder pastes (i.e. hydraulic binder and water without aggregates) and conglomerates (i.e. mixtures of hydraulic binder, aggregates and water).

Aggregates are inert substances which consist of unbroken or broken particles (e.g. stones, gravel), of natural (e.g. sand) or synthetic mineral substances. Examples of conglomerates are hydraulic mortars (mixture of hydraulic binder, water and fine aggregates) and concretes (mixture of hydraulic binder, water and coarse and fine aggregates).

Hardened products can be manufactured with the compositions comprising hydraulic binders. Prefabricated concrete parts (e.g. columns, crosses, floors, spanning members, holding girders, wall slabs, facade slabs), concrete products (pipes, paving slabs) and gypsum products (e.g. floor and wall slabs, panels) may be mentioned as examples of such products comprising hydraulic binders.

A selfcompacting composition comprising hydraulic binders is to be understood as meaning a composition which flows without separation up to virtually complete levelling, almost completely deaerates during flow and fills cavities without mechanical compaction.

A hydraulic binder is to be understood as meaning a binder which hardens with added water. Such binders are, for example, cement or hydraulic limes. Cement is preferably used.

Furthermore, a plasticizer may be used. This can preferably be selected from the group consisting of the lignin sulphonates, naphthalene sulphonates, melamine sulphonates, vinyl copolymers and/or polycarboxylates. Plasticizers based on polycarboxylates can particularly preferably be used.

Pyrogenic is to be understood as meaning metal oxide particles obtained by flame oxidation and/or flame hydrolysis. Oxidizable and/or hydrolysable starting materials are as a rule oxidized or hydrolysed in a hydrogen-oxygen flame. Organic and inorganic substances may be used as starting materials for pyrogenic processes. For example, directly available chlorides, such as silicon tetrachloride, aluminium chloride or titanium tetrachloride, are particularly suitable. Suitable organic starting compounds may be, for example, alcoholates, such as Si(OC₂H₅)₄, Al(OiC₃H₇)₃ or Ti(OiPr)₄. The metal oxide particles thus obtained are very substantially pore-free and have free hydroxyl groups on the surface. As a rule, the metal oxide particles are present at least partly in the form of aggregated primary particles. In the present invention, metalloid oxides, such as, for example, silica, are referred to as metal oxide.

In the case of pyrogenic oxides, the size of the specific surface area can be established in a controlled manner. It is also possible to achieve very large surface areas of up to 500 m²/g. In contrast, microsilicas are by-products of silicon metal production, so that the specific surface area cannot be adjusted to the same extent. Microsilicas are produced on an industrial scale only with small specific surface areas of 15-25 m²/g.

The pyrogenic metal oxides preferably have a BET surface area of 40 to 400 m²/g.

They are preferably selected from the group consisting of silica, titanium dioxide, alumina, zirconium dioxide, silicon-aluminium mixed oxide, silicon-titanium mixed oxide, titanium-aluminium mixed oxide and/or alkali metal-silica mixed oxide.

Furthermore, the following types can be used: CAB-O-SIL™ LM-150, LM-150D, M-5, M-5P, M-5DP, M-7D, PTG, HP-60; SpectrAl™ 51, 81, 100; all from Cabot Corp.; HDK S13, V15, V15P, N20, N20P, all from Wacker; REOLOSIL™ QS-10, QS-20, QS-30, QS-40, DM-10, all from Tokuyama.

TABLE 1
Metal oxide powder for the production of SCC

| | BET surface | Loss on drying | |
|---|---|---|---|
| Type | area [m²/g] | [% by weight] | pH |
| AEROSIL ® (SiO₂) | | | |
| 90 | 90 ± 15 | ≦1.0 | 3.7-4.7 |
| 130 | 130 ± 25 | ≦1.5 | 3.7-4.7 |
| 150 | 150 ± 15 | ≦0.5 | 3.7-4.7 |
| 200 | 200 ± 25 | ≦1.5 | 3.7-4.7 |
| 300 | 300 ± 30 | ≦1.5 | 3.7-4.7 |
| 380 | 380 ± 30 | ≦2.0 | 3.7-4.7 |
| 50 | 50 ± 15 | ≦1.5 | 3.8-4.8 |
| TT 600 | 200 ± 50 | ≦2.5 | 3.6-4.5 |
| OX50 | 50 ± 15 | ≦1.0 | 3.8-4.8 |
| AEROXIDE ® | | | |
| TiO₂ P25 | 50 ± 15 | ≦1.5 | 3.5-4.5 |
| MOX 80* | 80 ± 20 | ≦1.5 | 3.6-4.5 |
| MOX 170* | 170 ± 30 | ≦1.5 | 3.6-4.5 |
| Alu C (Al₂O₃) | 100 ± 15 | ≦5.0 | 4.5-5.5 |

*SiO₂/Al₂O₃

The pyrogenic metal oxides can also be present in surface-modified form. The following silanes can preferably be used for this purpose, individually or as a mixture:

Organosilanes (RO)₃Si(CₙH₂ₙ₊₁) and (RO)₃Si(CₙH₂ₙ₋₁)

where R=alkyl, such as methyl, ethyl, n-propyl, isopropyl or butyl and n=1-20.

Organosilanes R′ₓ(RO)₃Si(CₙH₂ₙ₊₁) and R′ₓ(RO)₃Si(CₙH₂ₙ₋₁)

where R=alkyl, such as methyl, ethyl, n-propyl, isopropyl or butyl; R′=alkyl, such as methyl, ethyl, n-propyl, isopropyl or butyl; R′=cycloalkyl; n=1-20; x+y=3, x=1, 2; y=1, 2.

Haloorganosilanes X₃Si(CₙH₂ₙ₊₁) and X₃Si(CₙH₂ₙ₋₁)

where X═Cl, Br; n=1-20.

Haloorganosilanes X₂(R′)Si(CₙH₂ₙ₊₁) and X₂(R′)Si(CₙH₂ₙ₋₁)

where X═Cl, Br, R′=alkyl, such as methyl, ethyl, n-propyl, isopropyl or butyl; R′=cycloalkyl; n=1-20

Haloorganosilanes X(R′)₂Si(CₙH₂ₙ₊₁) and X(R′)₂Si(CₙH₂ₙ₋₁)

where X═Cl, Br; R′=alkyl, such as methyl, ethyl, n-propyl, isopropyl or butyl; R′=cycloalkyl; n=1-20

Organosilanes (RO)₃Si(CH₂)ₘ—R′

where R=alkyl, such as methyl, ethyl or propyl; m=0, 1-20; R′=methyl, aryl, such as —C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH₂)₃Si(OR)₃, Sₓ—(CH₂)₃Si(OR)₃, SH, NR′R″R′″ where R′=alkyl, aryl; R″=H, alkyl, aryl; R′″═H, alkyl, aryl, benzyl, C₂H₄NR″″R′″″ where R″″═H, alkyl and R′″″═H, alkyl.

Organosilanes (R″)ₓ(RO)_{y}Si(CH₂)ₘ—R′

where R″=alkyl, x+y=3; cycloalkyl, x=1,2, y=1,2; m=0,1 to 20; R′=methyl, aryl, such as C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH₂)₃Si(OR)₃, Sₓ—(CH₂)₃Si(OR)₃, SH, NR′R″R′″ where R′=alkyl, aryl; R″=H, alkyl, aryl; R′″═H, alkyl, aryl, benzyl, C₂H₄NR″″R′″″ where R″″═H, alkyl and R′″″═H, alkyl.

Haloorganosilanes X₃Si(CH₂)ₙ—R′

X═Cl, Br; m=0, 1-20; R′=methyl, aryl, such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃) C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, -Sx-(CH₂)₃Si(OR)₃, where R=methyl, ethyl, propyl or butyl and x=1 or 2, SH.

Haloorganosilanes RX₂Si(CH₂)ₘR′

X═Cl, Br; m=0, 1-20; R′=methyl, aryl, such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N— (CH₂—CH₂—NH₂)₂, —OOC(CH₃) C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, -Sx-(CH₂)₃Si(OR)₃, where R=methyl, ethyl, propyl or butyl and x=1 or 2, SH.

Haloorganosilanes R₂XSiCH₂)ₘR′

X═Cl, Br; m=0, 1-20; R′=methyl, aryl, such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃) C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, -Sx-(CH₂)₃Si(OR)₃, where R=methyl, ethyl, propyl or butyl and x=1 or 2, SH.

Silazanes R′R₂SiNHSiR₂R′ where R,R′=alkyl, vinyl, aryl.

Cyclic polysiloxanes D3, D4, D5

D3, D4 and D5 being understood as meaning cyclic polysiloxanes having 3, 4 or 5 units of the type —O—Si(CH₃)₂, e.g. octamethylcyclotetrasiloxane=D4

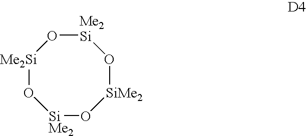

Polysiloxanes or silicone oils of the type

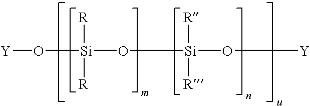

where
R=alkyl, aryl, (CH₂)ₙ—NH₂,H
R′=alkyl, aryl, (CH₂)ₙ—NH₂,H
R″=alkyl, aryl, (CH₂)ₙ—NH₂,H
R′″=alkyl, aryl, (CH₂)ₙ—NH₂,H
Y═CH₃, H, C_{z}H_{2z+1} where z=1-20,

### Si(CH₃)₃, Si(CH₃)₂H, Si(CH₃)₂OH, Si(CH₃)₂(OCH₃),

### Si(CH₃)₂(C_{z}H_{2z+1})

where
R′ or R″ or R′″ mean (CH₂)_{z}—NH₂ and
z=1-20,
m=0, 1, 2, 3, . . . ∞,
n=0, 1, 2 , 3, . . . ∞,
u=0, 1, 2, 3, . . . ∞.

The following substances can preferably be used as surface modifiers: octyltrimethoxysilane, octyltriethoxysilane, hexamethyldisilazane,

3-methacryloyloxypropyltrimethoxysilane, 3-methacryloyloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoxysilane, aminopropyltriethoxysilane.

Octyltrimethoxysilane, octyltriethoxysilane and dimethylpolysiloxanes can particularly preferably be used.

Suitable surface-modified metal oxides can be selected, for example, from the AEROSIL® and AEROXIDE® types mentioned in Table 2.

TABLE 2
Surface-modified metal oxides for SCC

| | BET | Loss on | | Carbon |
|---|---|---|---|---|
| | surface | drying | | content |
| | area | [% by | | [% by |
| Type | [m²/g] | weight] | pH | weight] |
| AEROSIL ® | | | | |
| R 972 | 110 ± 20 | ≦0.5 | 3.6-4.4 | 0.6-1.2 |
| R 974 | 170 ± 20 | ≦0.5 | 3.7-4.7 | 0.7-1.3 |
| R 104 | 150 ± 25 | — | ≧4.0 | 1.0-2.0 |
| R 106 | 250 ± 30 | — | ≧3.7 | 1.5-3.0 |
| R 202 | 100 ± 20 | ≦0.5 | 4.0-6.0 | 3.5-5.0 |
| R 805 | 150 ± 25 | ≦0.5 | 3.5-5.5 | 4.5-6.5 |
| R 812 | 260 ± 30 | ≦0.5 | 5.5-7.5 | 2.0-3.0 |
| R 816 | 190 ± 20 | ≦1.0 | 4.0-5.5 | 0.9-1.8 |
| R 7200 | 150 ± 25 | ≦1.5 | 4.0-6.0 | 4.5-6.5 |
| R 8200 | 160 ± 25 | ≦0.5 | ≧5.0 | 2.0-4.0 |
| R 9200 | 170 ± 20 | ≦1.5 | 3.0-5.0 | 0.7-1.3 |
| AEROXIDE ® | | | | |
| TiO₂ T805 | 45 ± 10 | — | 3.0-4.0 | 2.7-3.7 |
| TiO₂ NKT90 | 50-75 | — | 3.0-4.0 | 2.0-4.0 |
| Alu C 805 | 100 ± 15 | — | 3.0-5.0 | — |

Furthermore, structurally modified metal oxides, as disclosed, for example, in EP-A-1199336, DE-A-10239423, DE-A-10239424 or WO2005095525, can be used.

The pyrogenic metal oxide can be used as powder or in the form of a dispersion. The use in the form of a dispersion may be advantageous compared with the use as powder if dust contamination is to be avoided. The proportion of the pyrogenic metal oxide in the dispersion may be between 5 and 50% by weight, as a rule the content being 15 to 40% by weight. The dispersions preferably have water as the main constituent of the liquid phase. In addition, they may contain stabilizing additives to prevent sedimentation and reagglomeration.

Further advantages of a dispersion are obtained if the metal oxide particles in the dispersion have a mean diameter of, preferably, 50 to 500 nm and particularly preferably one of 70 to 300 nm. This range is technically realizable by commercially available dispersing aggregates (high-energy milling). The extreme fineness can lead to an improved quality of the SCC. For this purpose, experiments are necessary to determine the optimum conditions.

Suitable commercially available dispersions of pyrogenic metal oxide powders are shown in Table 3.

### EXAMPLES

### Starting Materials

1) Composition for the production of a selfcompacting mortar having the following composition:
   700 g of sand
   450 g of cement (CEM I 52.5 R)
   8 g of plasticizer (Superflow 40E from W.R. Grace, 30% solution of a polycarboxylate)
   90 g of fly ash (Safament)
   150 g of water
2) Silica fume, (Microsilica® G983, Elkem), specific surface area 20 m²/g, 98% of SiO₂
3) Silica sol (Köstrosol® 3550, Chemische Werke Bad Köstritz), specific surface area 80 m²/g
4) A) AEROSIL® 90, B) AEROSIL® 200, C) AEROSIL® 300, cf. Table 1
5) AERODISP® 7215 S, cf. Table 3.
6) AEROXIDE® TiO₂ P25, cf. Table 1
7) AEROXIDE® MOX 170, cf. Table 1

TABLE 3
Suitable dispersions of pyrogenic metal oxides for
the production of SCC

| | Solids | | |
|---|---|---|---|
| | content | | |
| | % by | | Viscosity |
| | weight | pH¹⁾ | mPa · s²⁾ |
| Silica | | | |
| AERODISP ® W 7520 | 20 | 9.5-10.5 | ≦100 |
| AERODISP ® W 7520 N | 20 | 9.5-10.5 | ≦100 |
| AERODISP ® W 7622 | 22 | 9.5-10.5 | ≦1000 |
| AERODISP ® W 1226 | 26 | 9-10 | ≦100 |
| VP Disp. W 1450 | 50 | 9-10 | ≦10000 |
| AERODISP ® W 1714 | 14 | 5-6 | ≦100 |
| AERODISP ® W 1824 | 24 | 5-6 | ≦150 |
| AERODISP ® W 1836 | 34 | 4-6 | ≦200 |
| AERODISP ® W 7215 S | 15 | 5-6 | ≦100 |
| AERODISP ® W 7512 S | 12 | 5-6 | ≦100 |
| VP Disp. W 340 | 40 | 3.5-5.5 | ≦1000 |
| Alumina | | | |
| AERODISP ® WK 341 | 41 | 2.5-4 | ≦1000 |
| VP Disp. WK 7330 | 30 | 2.5-4 | ≦1000 |
| AERODISP ® W 630 | 30 | 3-5 | ≦2000 |
| VP Disp. W 640 ZX | 40 | 6-9 | ≦2000 |
| VP Disp. W 630 X | 30 | 3-5 | ≦500 |
| VP Disp. W 440 | 40 | 3-5 | ≦1000 |
| Titanium dioxide | | | |
| VP Disp. W 740 X | 40 | 6-9 | ≦10000 |
| VP Disp. W 2730 X | 30 | 6-8 | ≦5000 |

¹⁾based on EN ISO 787-9; 2) measured according to DIN EN ISO 3219 at a shear rate of 100 s⁻¹

### Examples 1 to 11

The metal oxides 2-7 are added to the composition mentioned under 1), according to the amounts mentioned in Table 4.

In Comparative Examples 2 and 3, these are nonpyrogenic metal oxides.

The examples according to the invention comprise pyrogenic silica powders (Examples 4-6), an aqueous dispersion of a pyrogenic silica powder (Example 7), a pyrogenic titanium dioxide powder (Example 8) and a silicon-aluminium mixed oxide powder (Example 9). Furthermore, the table comprises Comparative Examples 10 and 11 in which pyrogenic metal oxides are used but in which the product of BET surface area and concentration is outside the claimed range.

In comparison with the reference without metal oxide (Example 1), all examples except for Comparative Example 10 have a high early strength after 24 hours. In Comparative Example 10, the metal oxide concentration is only 9 m²/100 g of cement and is therefore too low.

Comparative Examples 2 and 3 show a substantially smaller increase in the early strength than the examples with pyrogenic metal oxides.

In Comparative Example 11 comprising metal oxide in an amount of 400 m²/100 g of cement, only a slump of 11.8 cm is achieved. The mortar is therefore not selfcompacting.

TABLE 4
Starting materials and analytical values of mortars

| | | Proportion | Proportion | | | Flexural | |
|---|---|---|---|---|---|---|---|
| | | of metal | of metal | | Compressive | tensile | |
| | Added | oxide | oxide | | strength | strength | |
| | metal | % by | m²/100 g of | Slump | 24 h | 24 h | SCC |
| Example | oxide | weight | cement | cm | N/mm² | N/mm² | yes/no |
| 1 (Comp.) | None | — | — | 31.8 | 10.6 | 2.7 | yes |
| 2 (Comp.) | 2 | 2 | 40 | 24.0 | 17.6 | 5.3 | yes |
| 3 (Comp.) | 3 | 2 | 160 | 24.5 | 15.6 | 4.4 | yes |
| 4 | 4A | 2 | 180 | 24.0 | 31.6 | 10.2 | yes |
| 5 | 4B | 1 | 200 | 24.0 | 32.0 | — | yes |
| 6 | 4C | 0.75 | 225 | 24.2 | 28.5 | — | yes |
| 7 | 5 | 2 | 180 | 24.5 | 30.9 | 9.9 | yes |
| 8 | 6 | 1 | 50 | 27.6 | 31.5 | — | yes |
| 9 | 7 | 1 | 170 | 24.5 | 29.6 | — | yes |
| 10 (Comp.) | 4 | 0.1 | 9 | 30.2 | 12.1 | — | yes |
| 11 (Comp.) | 5 | 2 | 400 | 11.8 | — | — | no |

### Example 12

Various amounts of from 0 to 13.5 g of the metal oxide 4A) are added to the composition mentioned under 1), corresponding to 0 to 270 m² of metal oxide/100 g of hydraulic binder (cf. Table 5).

TABLE 5

| Added | | | |
|---|---|---|---|
| Aerosil | | | Compressive |
| % by weight | Added | m² of metal | strength after |
| of the | Aerosil | oxide/100 g of | 24 h |
| cement | g | cement | N/mm² |
| 0 | 0 | 0 | 10.6 |
| 0.1 | 0.45 | 9 | 12.3 |
| 0.5 | 2.25 | 45 | 18.2 |
| 1 | 4.5 | 90 | 22.1 |
| 1.5 | 6.75 | 135 | 28.9 |
| 2 | 9 | 180 | 31.5 |
| 2.5 | 11.3 | 225 | 29.8 |
| 3 | 13.5 | 270 | 23.8 |

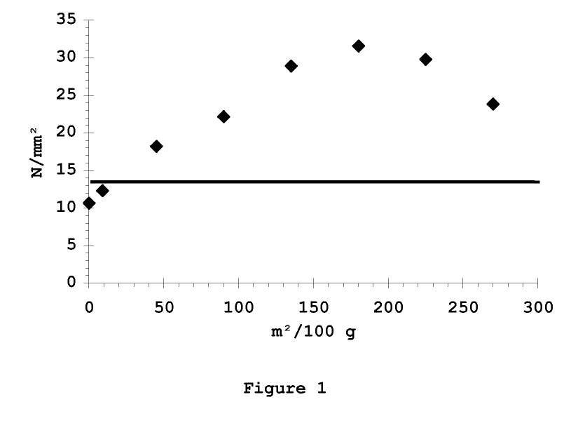

After 24 hours, the compressive strength is measured on the basis of DIN EN 196-1. The resulting compressive strengths in N/mm² are shown in FIG. 1 as a function of the amount of metal oxide in m² of metal oxide per 100 g of hydraulic binder (m²/100 g).

FIG. 1 clearly shows that the desired increase in early strength of +30% compared with the reference (solid line in FIG. 1) is not achieved in the case of an amount of metal oxide of <10 m²/100 g of cement.

Amounts of metal oxide of >200 m²/100 g of cement do not lead to any further increase in the early strength. Even larger amounts even lead to a decrease.

1. A pyrogenic metal oxide for the manufacture of a selfcompacting composition comprising hydraulic binders and having high early strength,
the composition comprising at least one hydraulic binder and water as further constituents and
the product of the BET surface area, in m²/g, of the pyrogenic metal oxide and the proportion by weight of the pyrogenic metal oxide, based on the hydraulic binder, being 20 to 200 m²/100 g of hydraulic binder.

2. The pyrogenic metal oxide according to claim 1, wherein the BET surface area of the pyrogenic metal oxide is 40 to 400 m²/g.

3. The pyrogenic metal oxide according to either of claims 1, wherein the pyrogenic metal oxide is silica, titanium dioxide, alumina, zirconium dioxide, silicon-aluminium mixed oxide, silicon-titanium mixed oxide, titanium-aluminium mixed oxide and/or alkali metal-silica mixed oxide.

4. The pyrogenic metal oxide according to claim 1, wherein the pyrogenic metal oxide is present in surface-modified form.

5. The pyrogenic metal oxide according to claim 1, wherein the pyrogenic metal oxide is present in the form of a dispersion.

6. The pyrogenic metal oxide according to claim 5, wherein the mean aggregate diameter of the particles of the pyrogenic metal oxide in the dispersion is less than 500 nm.
